(19) United States
(12) Patent Application Publication
(10) Pub. No.: US 2009/0276969 A1
(43) Pub. Date: Nov. 12, 2009

(54) Portable Track-Out Prevention Systems

(76) Inventors: Carl J. Buetzow, Peoria, AZ (US); Leroy S. Nelson, Laveen, AZ (US)

Correspondence Address: Stoneman Volk Patent Group, 3770 NORTH 7TH STREET, Suite 100, PHOENIX, AZ, 85014, US

(21) Appl. No.: 12/434,525

(22) Filed: May 1, 2009

Related U.S. Application Data
(60) Provisional application No. 61/052,237, filed on May 11, 2008.
(60) Provisional application No. 61/105,757, filed on Oct. 15, 2008.
(60) Provisional application No. 61/153,826, filed on Feb. 19, 2009.

(51) Int. Cl. B60S 3/00

(52) U.S. Cl. 15/53.4

(57) ABSTRACT

A portable system for preventing the “track out” of dust, mud, and similar debris by vehicles leaving a construction site. The system provides a plurality of rollers in combination with vibratory structures designed to rotate and vibrate the vehicle tires in order to dislodge debris from the vehicle.

### CROSS-REFERENCE TO RELATED APPLICATION

The present application is related to and claims priority from prior provisional application Ser. No. 61/052,237, filed May 11, 2008, entitled “PORTABLE TRACK-OUT PREVENTION SYSTEMS”; and, is related to and claims priority from provisional application Ser. No. 61/105,757, filed Oct. 15, 2008, entitled “PORTABLE TRACK-OUT PREVENTION SYSTEMS”; and, is related to and claims priority from provisional application Ser. No. 61/153,826, filed Feb. 19, 2009, entitled “PORTABLE TRACK-OUT PREVENTION SYSTEMS”; the contents of all of which are incorporated herein by this reference and are not admitted to be prior art with respect to the present invention by the mention in this cross-reference section.

### BACKGROUND

This invention relates to providing a track-out prevention system. More particularly, this invention relates to providing a portable system for preventing the “track out” of dust, mud, and similar debris by vehicles leaving a construction site.

It is often desirable for environmental and other reasons, or required by regulation, to remove dust, mud, or other materials that may be deposited on a public roadway by a vehicle leaving a construction site prior to such vehicle traveling on such public roadway. Currently, vehicles are manually cleaned of such debris using time-consuming and labor intensive processes; systems to increase the efficiency of this process would be of value to many.

### OBJECTS AND FEATURES OF THE INVENTION

A primary object and feature of the present invention is to provide a system overcoming the above-mentioned problems.

It is a further object and feature of the present invention to provide such a system to efficiently remove dirt, mud, and debris that may be deposited on a public roadway from a vehicle prior to leaving a site from which such vehicle has acquired such matter.

It is a further object and feature of the present invention to provide such a system with a mobile apparatus that may be transported over public roadways and user-placed as needed on a site to efficiently remove dirt, mud, and debris from vehicles.

It is a further object and feature of the present invention to provide such a system that uses greatly reduced or zero water for such debris removal from vehicles.

It is a further object and feature of the present invention to provide such a system to efficiently remove dirt, mud, and other debris from the undercarriage of a vehicle.

A further primary object and feature of the present invention is to provide such a system that is efficient, inexpensive, and durable. Other objects and features of this invention will become apparent with reference to the following descriptions.

### SUMMARY OF THE INVENTION

In accordance with a preferred embodiment hereof, this invention provides a system relating to the removal of surface accumulations of debris from at least one vehicle having a plurality of rolling tires rotationally mounted thereon, such system comprising: at least one vehicle support structured and arranged to support the at least one vehicle in at least one substantially stationary position; wherein such at least one vehicle support comprises at least one tire rotator structured and arranged to essentially contemporaneously rotate substantially each one of the plurality of rolling tires of the at least one vehicle supported by such at least one vehicle support; wherein such at least one tire rotator comprises at least one power extractor structured and arranged to extract rotational power from the at least one vehicle; wherein such at least one tire rotator operates substantially by such rotational power derived from the at least one vehicle; and wherein rotation of the plurality of rolling tires by such at least one tire rotator assists in dislodging debris from the at least one vehicle.

Moreover, it provides such a system wherein such at least one vehicle support further comprises: at least one wheel-assisted towing assembly structured and arranged to assist wheeled towing of such at least one vehicle support; wherein such at least one wheel-assisted towing assembly comprises at least one wheel set structured and arranged to assist rolling movement of such at least one vehicle support; and at least one hitch coupler structured and arranged to assist hitch coupling of such at least one vehicle support to at least one towing vehicle. Additionally, it provides such a system wherein such at least one power extractor comprises at least one contact interaction between at least one powered rolling tire of the plurality of rolling tires and such at least one tire rotator. Also, it provides such a system wherein such at least one vehicle support further comprises: at least one elevated platform structured and arranged to support the at least one vehicle above a ground surface; at least one vehicle entry ramp structured and arranged to provide ramp-assisted vehicle entry of the at least one vehicle onto such at least one vehicle support; and at least one vehicle exit ramp structured and arranged to provide ramp-assisted vehicle exiting of the at least one vehicle from such at least one vehicle support.

In addition, it provides such a system wherein such at least one vehicle entry ramp and such at least one vehicle exit ramp are substantially detachable from such at least one vehicle support to assist such wheel-assisting towing. And, it provides such a system wherein such at least one vehicle support further comprises: at least one secondary debris-dislodger structured and arranged to provide secondary dislodging of debris from the at least one vehicle; wherein such at least one secondary debris-dislodger comprises at least one vibration-inducing surface structured and arranged to induce debris-dislodging vibrations in the at least one vehicle during movement of the at least one vehicle over such at least one secondary debris-dislodger.

Further, it provides such a system wherein: such at least one vehicle entry ramp comprises at least one portion of such at least one secondary debris-dislodger; and such at least one vehicle entry ramp is further structured and arranged to dislodge debris from the at least one vehicle during such vehicle entry. Even further, it provides such a system wherein: such at least one vehicle exit ramp comprises at least one portion of such secondary debris-dislodger; and such at least one vehicle exit ramp is further structured and arranged to dislodge debris from the at least one vehicle during such vehicle exit.

Moreover, it provides such a system wherein such at least one vibration-inducing surface substantially comprises a plurality of spaced-apart transverse bars located substantially within the drive path of the at least one vehicle. Additionally, it provides such a system wherein such at least one vibration-inducing surface substantially comprises at least one area of loose aggregate material located substantially within the drive path of the at least one vehicle. Also, it provides such a system wherein such at least one tire rotator comprises: at least one set of wheel-mounted road tires structured and arranged to support the plurality of rolling tires; at least one set of vehicle-drive-train differentials structured and arranged to rotationally support such set of wheel-mounted road tires; and at least one set of torque couplers structured and arranged to couple the torque received through at least one vehicle-drive-train differential to essentially all other vehicle-drive-train differentials of such at least one set.

In addition, it provides such a system wherein such at least one tire rotator further comprises at least one power take-off structured and arranged to extract usable power from a portion of the torque received through such at least one vehicle-drive-train differential. And, it provides such a system further comprising: at least one brake structured and arranged to brake such at least one tire rotator; and at least one user control structured and arranged to assist user control of such at least one brake. Further, it provides such a system further comprising: at least one air pump structured and arranged to pressurize air by pumping; at least one air-storage reservoir structured and arranged to store a volume of pressurized air; at least one pneumatically-powered brake actuator structured and arranged to assist pneumatic actuation of such at least one brake; at least one pneumatic circuit structured and arranged to operably couple such at least one air-storage reservoir and such at least one pneumatically-powered brake actuator; and at least one pneumatic control valve structured and arranged to control the application of such pressurized air at such at least one pneumatically-powered brake actuator; wherein the operation of such at least one pneumatic control valve is substantially controlled by such at least one user control; and wherein the operation of such at least one air pump is enabled using the usable power provided at such at least one power take-off.

Even further, it provides such a system further comprising at least one positional restraint structured and arranged to restrain the at least one vehicle in a substantially fixed position relative to such at least one vehicle support. Moreover, it provides such a system further comprising at least one mechanically-powered lift structured and arranged to lift such at least one vehicle support to at least one position assisting placement of such at least one wheel-assisted towing assembly and coupling to the at least one towing vehicle.

In accordance with another preferred embodiment hereof, this invention provides a method relating to the removal of surface accumulations of debris from at least one vehicle having a plurality of rolling tires rotationally mounted thereon, such method comprising the steps of: supporting the at least one vehicle in at least one substantially stationary position; engaging the plurality of rolling tires within at least one tire rotator structured and arranged to essentially contemporaneously rotate substantially each one of the plurality of rolling tires; extracting rotational power from the at least one vehicle; operating such at least one tire rotator using such extracted rotational power; and dislodging debris from the at least one vehicle by rotation of the plurality of rolling tires by such tire rotator.

Even further, it provides such a system wherein such at least one tire rotator comprises: at least one plurality of supportive rollers structured and arranged to rotatably support the plurality of rolling tires; and at least one set of torque couplers structured and arranged to couple the torque received through at least one supportive roller of such at least one plurality of supportive rollers to substantially all other such supportive rollers of such at least one plurality. Moreover, it provides such a system wherein each such at least one supportive roller comprises: at least one elongated bar comprising at least one first end portion, at least one second end portion, and at least one center portion situate therebetween; at least one centering assembly structured and arranged to assist in maintaining the at least one rolling tire in at least one supported position proximate to such at least one center portion.

Additionally, it provides such a system wherein such at least one centering assembly comprises: proximate with such at least one first end portion, at least one first frustoconical portion comprising a diameter increasing with distance from such at least one center portion; proximate with such at least one second end portion, at least one second frustoconical portion comprising a diameter increasing with distance from such at least one center portion; wherein such at least one elongated bar comprises at least one rotational axis; and wherein such at least one first frustoconical portion and such at least one second frustoconical portion are disposed substantially coaxially with such at least one rotational axis. Also, it provides such a system wherein such at least one set of torque couplers comprises at least one power-distributing chain drive structured and arranged to distribute rotary power between substantially each at least one rotatable bar of such at least one plurality.

In addition, it provides such a system wherein: such at least one elongated bar further comprises at least one portion of such at least one secondary debris-dislodger; and such at least one portion of such at least one secondary debris-dislodger comprises at least one uneven outer peripheral surface of such at least one rotatable bar. And, it provides such a system wherein such at least one tire rotator further comprises at least one power take-off structured and arranged to extract usable power from a portion of the torque received through such at least one supportive roller of such at least one plurality of supportive rollers.

In accordance with another preferred embodiment hereof, this invention provides a system relating to prevention material track-out by at least one vehicle having a plurality of rolling tires rotationally mounted thereon, such system comprising: vehicle support means for supporting the at least one vehicle in at least one substantially stationary position; wherein such vehicle support means comprises tire rotator means for rotating substantially each one of the plurality of rolling tires of the at least one vehicle supported by such tire support means; wherein such tire rotator means comprises power extractor means for extracting rotational power from the at least one vehicle; wherein such tire rotator means substantially operates by such rotational power derived from the at least one vehicle; and wherein rotation of the plurality of rolling tires by such tire rotator means assists in dislodging debris from the at least one vehicle. Additionally, it provides such a system wherein such vehicle support means comprises: wheel-assisted towing means for wheel-assisting towing of such vehicle support means; wherein such wheel-assisted towing means comprises wheel means for assisting rolling movement of such vehicle support means; and hitch coupler means for hitch coupling such vehicle support means to at least one towing vehicle. Also, it provides such a system wherein such power extractor means comprises at least one contact interaction between at least one powered rolling tire of the plurality of rolling tires and such tire rotating means. In addition, it provides such a system wherein such vehicle support means further comprises: vehicle entry assister means for assisting vehicle entry of the at least one vehicle onto such vehicle support means; and vehicle exit assister means for assisting vehicle exiting of the at least one vehicle from such vehicle support means. And, it provides such a system wherein such vehicle entry assister means and such vehicle exit assister means are substantially detachable from such vehicle support. Further, it provides such a system wherein such vehicle support means further comprises: secondary debris-dislodger means for providing secondary dislodging of debris from the at least one vehicle; wherein such secondary debris-dislodger means comprises vibration-inducing surface means for inducing debris-dislodging vibrations during movement of the at least one vehicle over such secondary debris-dislodger means.

Even further, it provides such a system wherein such vehicle exit assister means comprises at least one portion of such secondary debris-dislodger means. Even further, it provides such a system wherein such vehicle entry assister means comprises at least one portion of such secondary debris-dislodger means for dislodging debris from the at least one vehicle during such vehicle entry. Even further, it provides such a system further comprising: braking means for braking such tire rotator means; and user control means for assisting user control of such braking means. Even further, it provides such a system further comprising lifter means for mechanically lifting such vehicle support means to assist at least one reconfiguration of such vehicle support means for operation with such wheel-assisted towing means and the at least one towing vehicle. In addition it provides each and every novel feature, element, combination, step and/or method disclosed or suggested by this patent application.

### BRIEF DESCRIPTION OF THE DRAWINGS

FIG. 1 shows a schematic diagram, illustrating a preferred vehicle debris-removal operation of a portable track-out prevention apparatus, according to preferred embodiments of the present invention.

FIG. 2 shows an enlarged schematic diagram illustrating the preferred vehicle debris-removal operation of the portable track-out prevention apparatus of FIG. 1.

FIG. 3 shows an overall plan view, of a portable track-out prevention apparatus, according to a first preferred embodiment of the present invention.

FIG. 4 shows an overall side view of the portable track-out prevention apparatus of FIG. 3.

FIG. 5 shows the partial enlarged plan view 5 of FIG. 3 illustrating a portion of the portable track-out prevention apparatus of FIG. 3.

FIG. 6 shows the partial enlarged side view 6 of FIG. 4 illustrating a portion of the portable track-out prevention apparatus of FIG. 3.

FIG. 7 shows the partial enlarged plan view 7 of FIG. 3 illustrating a portion of the portable track-out prevention apparatus of FIG. 3.

FIG. 8 shows the partial enlarged side view 8 of FIG. 4 illustrating a portion of the portable track-out prevention apparatus of FIG. 3.

FIG. 9 shows the partial enlarged plan view 9 of FIG. 7 illustrating a wheel rotation assembly of the portable track-out prevention apparatus of FIG. 3.

FIG. 10 shows the partial enlarged plan view 10 of FIG. 7 illustrating a front-wheel rotation subassembly of the portable track-out prevention apparatus of FIG. 3.

FIG. 11 shows the sectional view 11-11 of FIG. 9 illustrating preferred structural arrangements of the portable track-out prevention apparatus of FIG. 3.

FIG. 12 shows the partial enlarged side view 12 of FIG. 8 illustrating a portion of the portable track-out prevention apparatus of FIG. 3.

FIG. 13 shows the sectional view 13-13 of FIG. 9 illustrating preferred structural arrangements of the portable track-out prevention apparatus of FIG. 3.

FIG. 14 shows a partial cut-away perspective view, of the main chassis of the portable track-out prevention apparatus, according to the preferred embodiment of FIG. 3.

FIG. 15 shows a schematic diagram illustrating the pneumatic control arrangements of the portable track-out prevention apparatus of FIG. 3.

FIG. 16 shows a side view, in partial section, illustrating the portable track-out prevention apparatus configured for relocation by truck, according to the preferred embodiment of FIG. 3.

FIG. 17 shows a partial enlarged plan view, illustrating a preferred coupler assembly used to rotationally couple sets of adjacent gear boxes of a wheel rotation assembly, of the portable track-out prevention apparatus of FIG. 3.

FIG. 18 shows a plan view illustrating the preferred coupler assembly of FIG. 17.

FIG. 19 shows a sectional view through the section 19-19 of FIG. 18 further illustrating the preferred coupler assembly of FIG. 17.

FIG. 20 shows an overall plan view, of an alternate portable track-out prevention apparatus, according to a second preferred embodiment of the present invention.

FIG. 21 shows an overall side view of the alternate portable track-out prevention apparatus of FIG. 20.

FIG. 22 shows the partial enlarged plan view 22 of FIG. 20 illustrating a portion of the alternate portable track-out prevention apparatus of FIG. 20.

FIG. 23 shows the sectional view 23-23 of FIG. 22 illustrating preferred structural arrangements of the alternate portable track-out prevention apparatus of FIG. 20.

FIG. 24 shows a side view of a single support roller of the wheel rotation assembly of the alternate portable track-out prevention apparatus of FIG. 20.

FIG. 25 shows a partial side view illustrating the preferred drive coupling arrangements of the alternate portable track-out prevention apparatus of FIG. 20.

FIG. 26 shows a partial plan view illustrating the preferred drive coupling arrangements of the alternate portable track-out prevention apparatus of FIG. 20.

FIG. 27 shows the sectional view 27-27 of FIG. 24 illustrating preferred structures and arrangements the support roller of the alternate portable track-out prevention apparatus of FIG. 20.

FIG. 28 shows a partial side view illustrating an onboard lift mechanism used to lift the alternate portable track-out prevention apparatus from a ground-supported position to a raised position.

FIG. 29 shows a side view, illustrating the alternate portable track-out prevention apparatus being configured for relocation by truck, according to the preferred embodiment of FIG. 20.

FIG. 30 shows a side view, illustrating the alternate portable track-out prevention apparatus being configured for relocation by truck, according to the preferred embodiment of FIG. 20.

### DETAILED DESCRIPTION OF THE BEST MODES AND PREFERRED EMBODIMENTS OF THE INVENTION

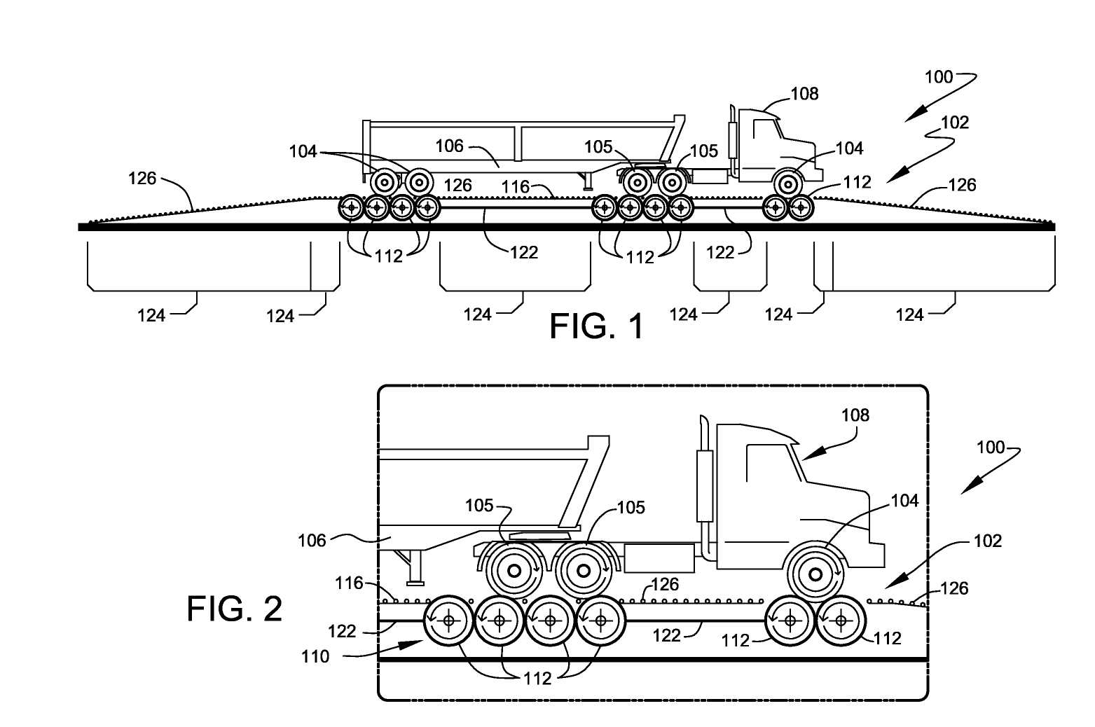

FIG. 1 shows a schematic diagram, illustrating a preferred vehicle debris-removal operation of preferred embodiments of track-out prevention system 100. FIG. 2 shows an enlarged schematic diagram, showing the preferred vehicle debris-removal operation of FIG. 1, according to the preferred embodiments of track-out prevention system 100. Preferred embodiments of track-out prevention system 100 preferably function to remove dirt (mud, debris, etc.) from wheels 104 and chassis 106 of vehicle 108. Preferred embodiments of track-out prevention system 100 preferably operate, in principle, by the simultaneous rotation of all road-going wheels 104 of vehicle 108, as diagrammatically illustrated in FIG. 1 and FIG. 2. This preferred action dislodges and removes debris from the wheels and tires by centripetal forces generated by the wheel rotation. Secondarily, debris is removed from vehicle 108 by preferred structures located along the path of the vehicle, as further described below.

Preferred embodiments of track-out prevention system 100 preferably comprise an elevated vehicle support platform 116 adapted to support vehicle 108 in a substantially stationary position, as shown. The preferred elevated arrangement of vehicle support platform 116 enables a preferred integration of a wheel rotation assembly 110 (at least embodying herein at least one tire rotator) within the platform structure, as shown. Wheel rotation assembly 110 preferably comprises a plurality of supportive wheel rotators 112 each preferably adapted to engage one or more rolling wheels 104 of vehicle 108, as illustrated in FIG. 1. Except as noted below, it is preferred that each wheel rotator 112 of wheel rotation assembly 110 be rotationally coupled to preferably provide essentially contemporaneous coordinated rotation of all road-going wheels 104 of vehicle 108, as shown in both FIG. 1 and FIG. 2. It is further preferred that the rotation of each wheel rotator 112 be power driven, most preferably power driven by rotational power extracted from the drive wheels 105 of vehicle 108. It is noted that drive wheels 105 preferably comprise those wheels coupled to the drive axles and power plant of vehicle 108 and which normally function to propel vehicle 108 during over-the-road travel. Each wheel rotator 112 is preferably intercoupled by a series of torque couplers 122 adapted to distribute the rotational power (torque) received from drive wheels 105 between wheel rotators 112 of wheel rotation assembly 110.

Wheel rotators 112 of wheel rotation assembly 110 are preferably located in positions within support platform 116 generally coinciding with the locations of the plurality of wheels 104 of vehicle 108, as shown. The preferred use of multiple rotators functions to accommodate trucks of various lengths. Upon reading this specification, those with ordinary skill in the art will now appreciate that, under appropriate circumstances, considering such issues as cost, operator preference, etc., other rotator arrangements such as, for example, utilizing a series of endless belts, rotating caterpillar-type tracks, etc., may suffice.

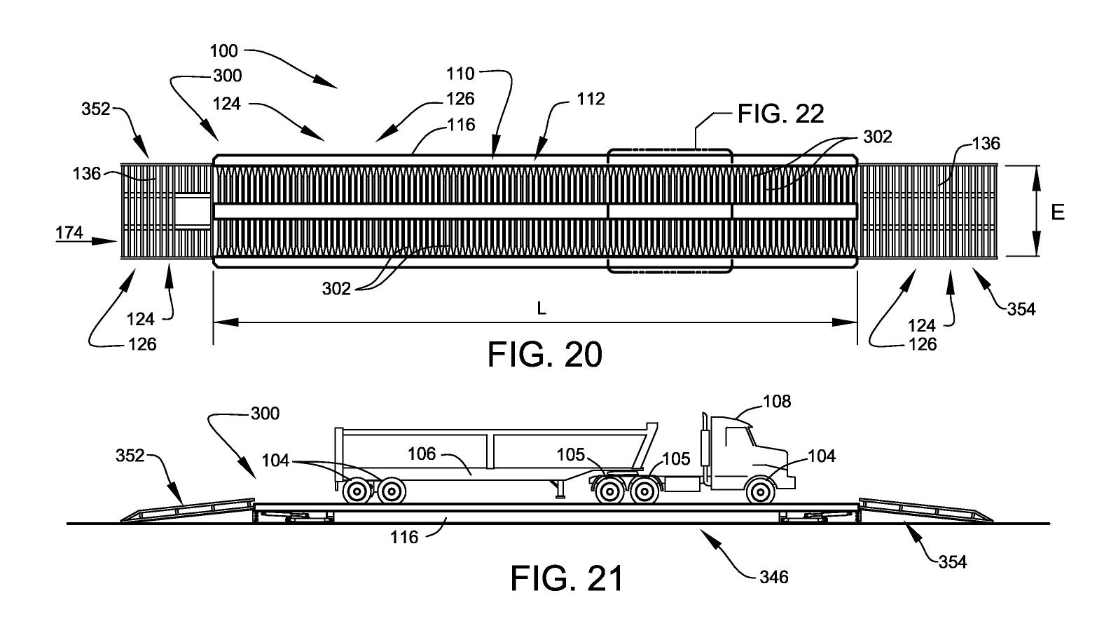

In addition to wheel rotation assembly 110, support platform 116 may preferably comprise multiple secondary debris-dislodging regions 124 structured and arranged to provide secondary dislodging of debris from vehicle 108. Each secondary debris-dislodging region 124 preferably comprises at least one vibration-inducing surface 126 structured and arranged to induce debris-dislodging vibrations within vehicle 108 during movement of vehicle 108 over support platform 116. It is noted that vibration-inducing surfaces 126 may preferably be incorporated within the support structures of wheel rotation assembly 110, as illustrated in the alternate preferred embodiment of FIG. 20.

The above-described system at least embodies herein a method relating to the removal of surface accumulations of debris from at least one vehicle having a plurality of rollable tires rotationally mounted thereon, such method comprising the steps of: supporting the at least one vehicle in at least one substantially stationary position; engaging the plurality of rolling tires within at least one tire rotator structured and arranged to essentially contemporaneously rotate substantially each one of the plurality of rollable tires; extracting rotational power from the at least one vehicle; operating such at least one tire rotator using such extracted rotational power; and dislodging debris from the at least one vehicle by rotation of the plurality of rollable tires by said tire rotator.

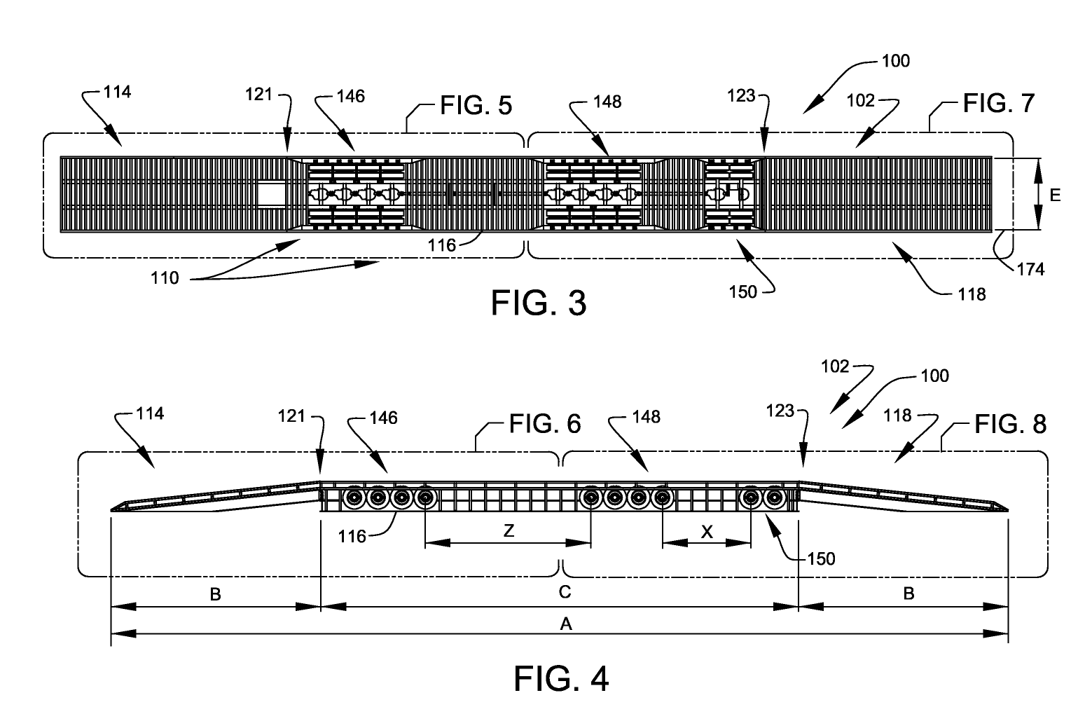

FIG. 3 shows an overall plan view of portable track-out prevention apparatus 102, according to a first preferred embodiment of track-out prevention system 100. FIG. 4 shows an overall side view of portable track-out prevention apparatus 102. FIG. 3 and FIG. 4 are provided to more clearly illustrate the preferred physical structures and arrangements of a preferred embodiment of portable track-out prevention apparatus 102. Both FIG. 3 and FIG. 4 illustrate portable track-out prevention apparatus 102 in a preferred operable configuration. In this preferred configuration, portable track-out prevention apparatus 102 comprises an overall length A of about 124 feet. Of this length, each ramp portion comprises a length B of about 30 feet with the remaining distance C of about 64 feet extending along the length of support platform 116. Portable track-out prevention apparatus 102 is also preferably capable of being shortened for road-going transport, as will be further explained in the descriptions of FIG. 16.

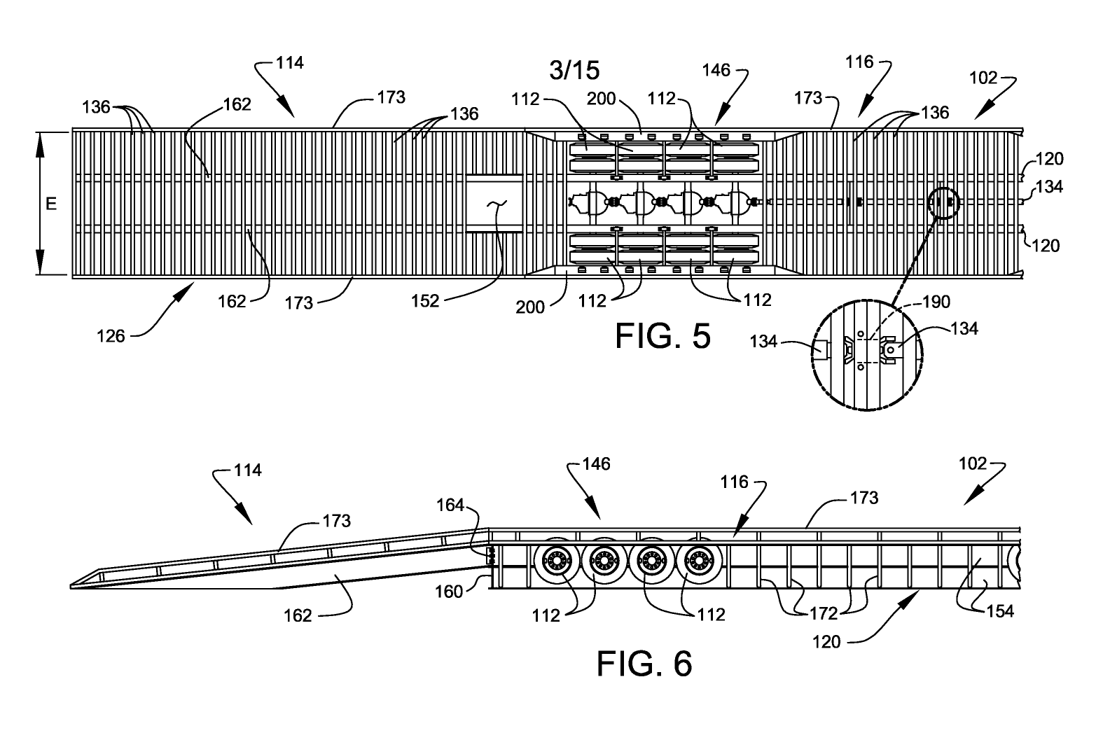

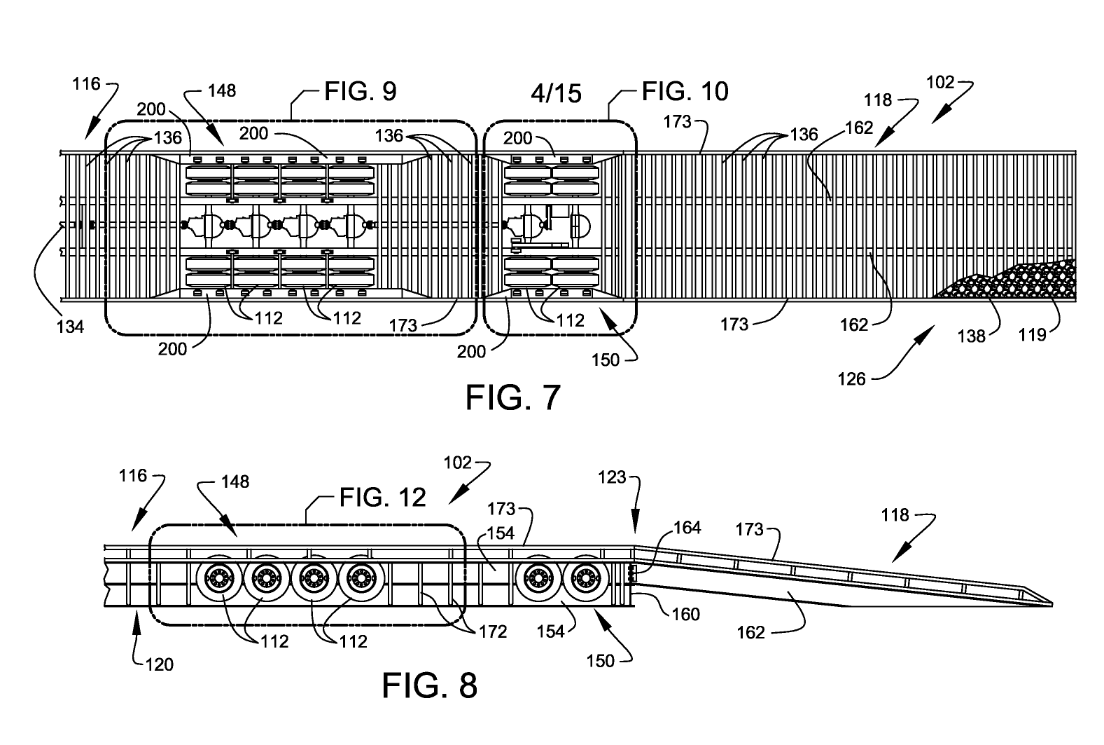

FIG. 5 shows the partial enlarged plan view 5 of FIG. 3 illustrating a portion of portable track-out prevention apparatus 102. FIG. 6 shows the partial enlarged side view 6 of FIG. 4. FIG. 7 shows the partial enlarged plan view 7 of FIG. 3 illustrating a portion of portable track-out prevention apparatus 102. FIG. 8 shows the partial enlarged side view 8 of FIG. 4 illustrating another side portion of portable track-out prevention apparatus 102. It is noted that the following descriptions make specific reference to FIG. 3 through FIG. 8 with continued reference to FIG. 1 and FIG. 2.

In preferred use, vehicle 108 accesses support platform 116 by traversing an upwardly inclined entry ramp 114, preferably positioned at first end 121 of support platform 116, as shown. A downwardly sloping exit ramp 114 is preferably located at second end 123 of support platform 116 to provide ramp-assisted exiting of vehicle 108 from support platform 116.

Both entry ramp 114 and exit ramp 114 preferably comprise secondary debris-dislodging regions 124, as shown. As noted previously, secondary debris-dislodging regions 124 preferably comprise vibration-inducing surfaces adapted to induce debris-dislodging vibrations in vehicle 108 as it drives over portable track-out prevention apparatus 102. Each secondary debris-dislodging region 124 preferably comprises a plurality of spaced-apart transverse bars 136 (see FIG.5) located substantially within the drive path 174 (see FIG. 3) of vehicle 108, as shown. Each transverse bar 136 preferably comprises a length of round tube steel having an outer diameter of about three inches and a wall thickness of about ¼ inch. Each transverse bar 136 is preferably rigidly mounted to the underlying support structure at a center-to-center spacing of about eight inches. The preferred spacing between transverse bars 136 produces a vigorous shaking of wheels 104, undercarriage, chassis 106, and body of vehicle 108, thus dislodging dirt, gravel and other debris from their surfaces. Furthermore, the open regions formed between adjacent transverse bars 136 preferably allows the dislodged debris to fall through the transverse bars 136 to the ground surface below, thus limiting the build-up of debris within the drive path 174 of vehicle 108.

Alternately preferably, secondary debris-dislodging region 124 may comprise one or more vehicle-supporting trays 138 containing granular aggregate material 119, such as crushed rock (or other gravel-like materials), preferably functioning to assist removal of dust and debris from the tires of vehicle 108 as they roll over structural tray 138. In an alternate preferred embodiment of the present invention, exit ramp 118 preferably comprises structural tray 138 containing granular aggregate material 119, as best illustrated in the partial cutaway view of FIG. 7 (at least embodying herein wherein such at least one vibration-inducing surface substantially comprises at least one area of loose aggregate material located substantially within the drive path of the least one vehicle).

Entry ramp 114 preferably comprises an open central region 152, substantially devoid of transverse bar 136, as best shown in FIG. 5. This open central region facilitates the transition of vehicle 108 between the incline of entry ramp 114 and the substantially horizontal support platform 116 and specifically addresses undercarriage interference issues in certain lower-clearance vehicles.

Wheel rotation assembly 110 is preferably divided into three separate wheel supporting regions identified herein as rear-wheel rotation subassembly 146, mid-wheel rotation subassembly 148, and front-wheel rotation subassembly 150. Each of the above-noted wheel supporting regions comprises a set of wheel rotators 112, as shown. The preferred spacing between the wheel rotation subassemblies is intended to accommodate a wide range of vehicle wheel bases, preferably including tractor and semitrailer combinations, as previously illustrated in the diagram of FIG. 1.

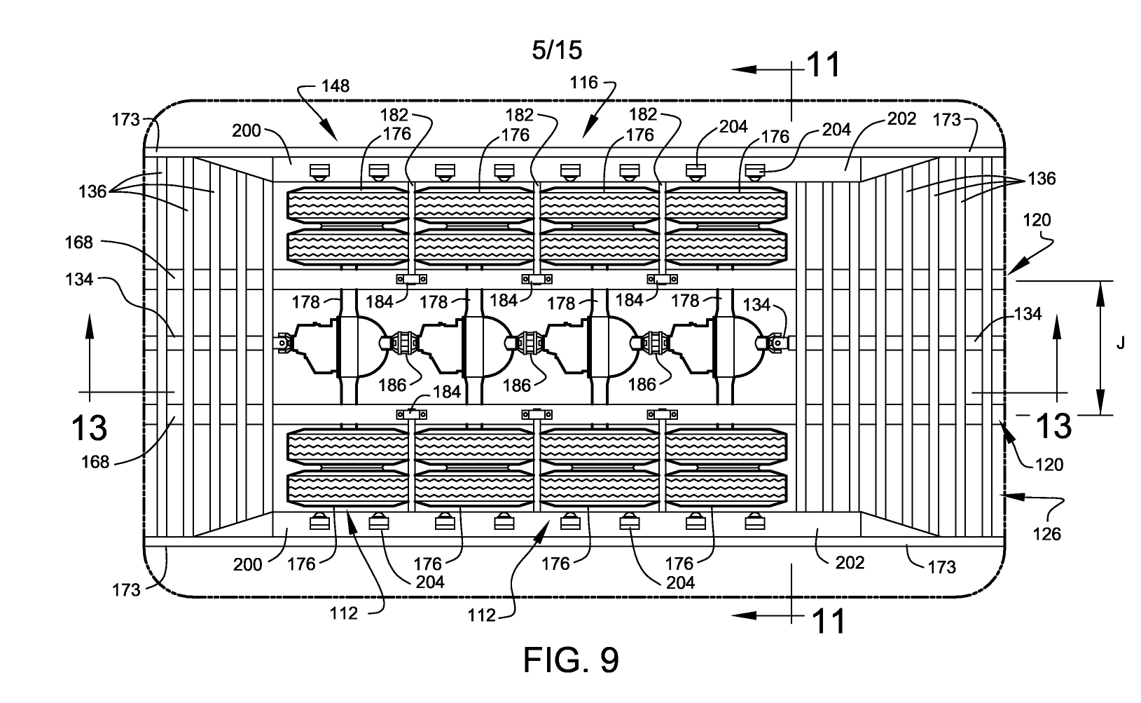

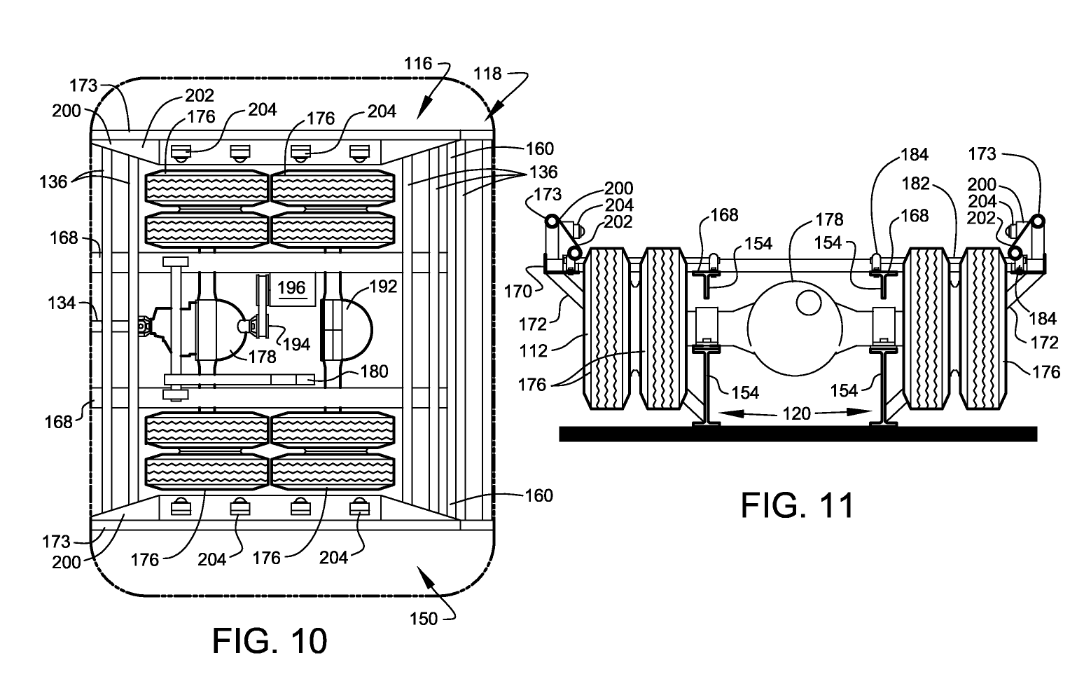

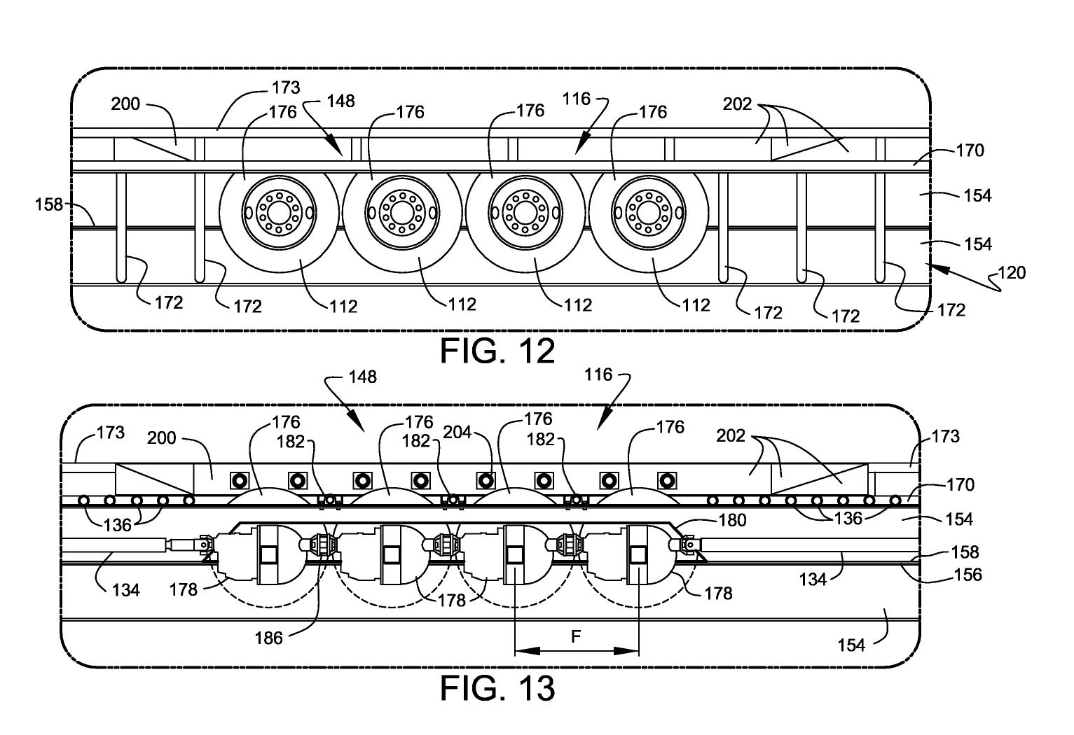

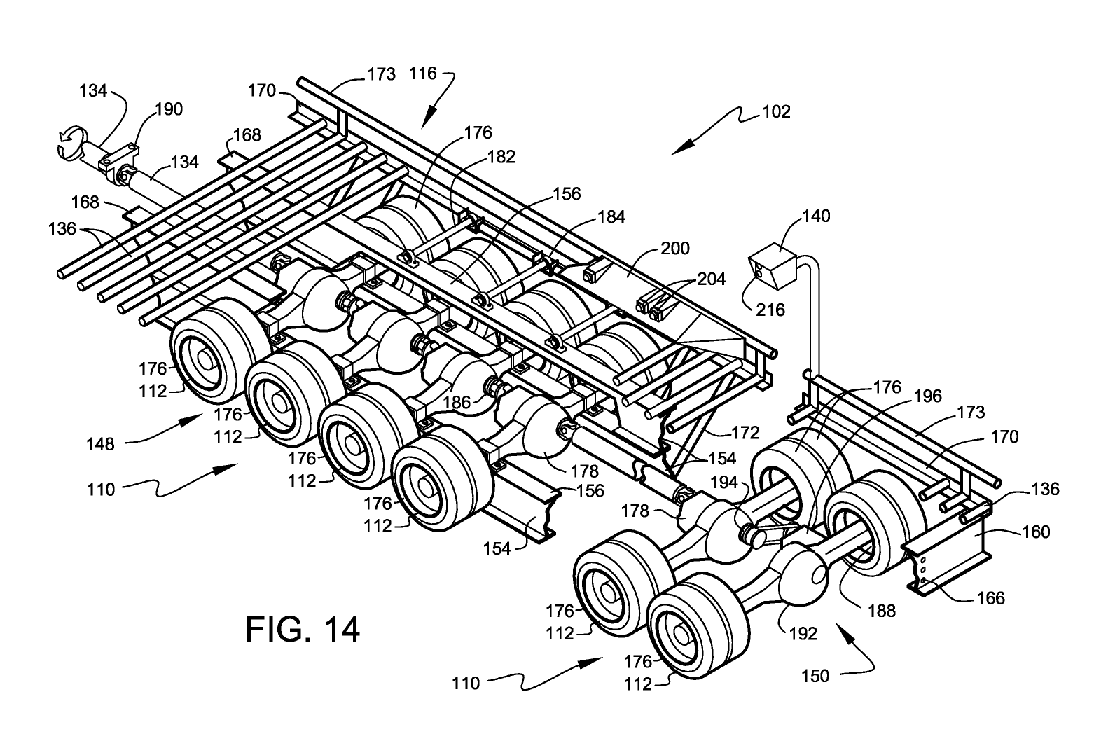

FIG. 9 shows the partial enlarged plan view 9 of FIG. 7 illustrating mid-wheel rotation subassembly 148 of portable track-out prevention apparatus 102. FIG. 10 shows the partial enlarged plan view 10 of FIG. 7 illustrating front-wheel rotation subassembly 150 of portable track-out prevention apparatus 102. FIG. 11 shows the sectional view 11-11 of FIG. 9 illustrating preferred structural arrangements of portable track-out prevention apparatus 102. FIG. 12 provides a partial enlarged side view 12 of FIG. 8 illustrating mid-wheel rotation subassembly 148. FIG. 13 shows the sectional view 13-13 of FIG. 9 illustrating preferred structural arrangements of mid-wheel rotation subassembly 148. FIG. 14 shows a partial cut-away perspective view of the main chassis of portable track-out prevention apparatus 102 according to the preferred embodiment of FIG. 1.

Portable track-out prevention apparatus 102 is preferably constructed around a pair of elongated structural members 120, preferably comprising a set of wide-flange-type beams 154, as shown. Each elongated structural member 120 of support platform 116 is preferably formed by vertically stacking two wide-flange-type beams 154, as shown. Both wide-flange-type beams 154 preferably comprise W 18×35 steel members. The vertically-stacked wide-flange-type beams 154 are preferably joined by thermally welding upper beam flange 156 of a lower wide-flange-type beam 154 to lower beam flange 158 of an upper wide-flange-type beam 154. Elongated structural members 120 are preferably terminated at first end 121 and second end 123 with a similarly vertically-stacked pair of perpendicularly oriented end beams 160, preferably comprising wide-flange members of matching depth.

The longitudinal webs of the elongated structural members 120 comprise a preferred center-to-center spacing J of about 40 inches, as noted in FIG. 9. Upon reading the teachings of this specification, those of ordinary skill in the art will now understand that, under appropriate circumstances, considering such issues as intended use, cost, etc., other arrangements, such as locating such structural members toward the peripheral edges of the platform, utilizing alternate bridge-like structures, utilizing alternate box beam construction, etc., may suffice.

Both entry ramp 114 and exit ramp 118 each comprise a single pair of parallel wide-flange-type beams 162, also preferably comprising W 18×35 members. The lower portion of each wide-flange-type beam 162 is taper cut, as shown, to allow the distal ends of the ramps to rest near ground level. The upper proximal ends of each wide-flange-type beam 162 are preferably modified to comprise bolted connection 164, as shown. Bolted connection 164 provides a preferred means for removably attaching a ramp to a respective end of support platform 116 and is thus instrumental in facilitating the reconfiguration of portable track-out prevention apparatus 102 for transport. Bolted connection 164 preferably engages a complementary set of bolt apertures 166 located at the upper end beams 160 (see FIG. 14).

Transverse bars 136 of support platform 116 are preferably supported by the upper-most beam flange 168 of elongated structural members 120, as shown, and are preferably affixed to the supporting flange surfaces by thermal welding. The preferred support and attachment of transverse bars 136 to wide-flange-type beams 162 of entry ramp 114 and exit ramp 118 are substantially similar.

The outer ends of each transverse bar 136 are supported by a continuous elongated support member, more preferably an L-shaped metal angle, most preferably a 4 inch×4 inch steel angle 170, as shown. Steel angles 170 of support platform 116 are preferably supported by diagonal braces 172 extending between the horizontal leg of steel angle 170 and the lower wide-flange-type beam 154 of elongated structural members 120, as shown. The diagonal braces 172 are preferably omitted within the preferred structures of entry ramp 114 and exit ramp 118, as shown.

A protective guide rail 173 preferably extends along each side of support platform 116 to assist the vehicle operator in maintaining vehicle 108 in a safe supported position within the intended path of travel. Each guide rail 173 preferably comprises a length of round tube steel having an outer diameter of about three inches. Each guide rail 173 runs concurrently with steel angle 170 at an elevation about 14 inches vertically above the horizontal leg of the adjacent angle. A matching set of protective guide rails 172 preferably extend along the sides of entry ramp 114 and exit ramp 118, as shown.

Protective guide rails 172 generally define a preferred drive path 174 having a clear width E of at least about 106 inches. This preferred width is preferably maintained along substantially the entire length A of portable track-out prevention apparatus 102, as shown, and is of sufficient width to accommodate most road-going vehicles. Upon reading this specification, those with ordinary skill in the art will now appreciate that, under appropriate circumstances, considering such issues as vehicle type, nature of the local site operations, etc., other width arrangements such as, for example, wider drive paths to accommodate larger earth-moving apparatus, etc., may suffice.

Rear-wheel rotation subassembly 146, mid-wheel rotation subassembly 148, and front-wheel rotation subassembly 150 each preferably comprise a plurality of wheel rotators 112, preferably comprising tandem sets of rotating wheels, more preferably tandem sets of wheel-mounted road tires 176 rotatably supported by tandem sets of torque-transmitting axles 178, as shown. Both rear-wheel rotation subassembly 146 and mid-wheel rotation subassembly 148 preferably comprise a grouping of four torque-transmitting axles 178 rotationally supporting sixteen wheel-mounted road tires 176, as shown. Front-wheel rotation subassembly 150 preferably comprises one torque-transmitting axle 178 and one idler axle 192 together rotationally supporting eight wheel-mounted road tires 176, as shown.

Each torque-transmitting axle 178 preferably comprises a drive axle sourced from a heavy truck powertrain, such as, for example, tandem drive-axles produced by Freightliner Trucks (a division of Daimler Trucks North America LLC of Portland Oreg.). Such heavy-truck drive axles preferably utilize a differential assembly, preferably a Rockwell® power-dividing differential assembly having a preferred gear ratio of about 3.73. The Rockwell® differential assembly is preferably modified to prevent differential rotation of the opposing wheel-mounted road tires 176. This modification is preferably accomplished by welding the planetary spider gears within the differential carrier.

Wheel-mounted road tires 176 are preferably mounted to torque-transmitting axles 178 in pairs, in an arrangement commonly referred to as “dualies”, preferably comprising dual-wheel assemblies bolt-mounted to the drum and hub assemblies 188 located at each side of the axle, as shown. This preferred arrangement closely corresponds to common wheel/axle combinations of vehicle 108. Upon reading this specification, those with ordinary skill in the art will now appreciate that, under appropriate circumstances, considering such issues as cost, vehicle type/size, etc., other wheel rotator arrangements such as, for example, the use of 24-inch wide caterpillar-type treads, endless belt assemblies, “super single” wheels, etc., may suffice.

The drum and hub assemblies 188 preferably comprise braking assemblies, which can be pneumatically operated to slow or stop the wheel-mounted road tires 176. Wheel-mounted road tires 176 preferably comprise rubber truck tires, preferably commercial-type truck tires having a preferred size of 255/70R 22.5 with an outer diameter of about 40.5 inches.

Each torque-transmitting axle 178 is rigidly mounted to upper beam flange 156 of the lower wide-flange-type beam 154, as shown. An approximately nine-inch high opening 180 is cut in the vertical web of the upper wide-flange-type beam 154 to allow torque-transmitting axles 178 to pass therethrough, as shown. Each torque-transmitting axle 178 preferably comprises an axle-to-axle spacing F of about 37-¾ inches. This preferred spacing provides about a one-inch gap between adjacent wheel-mounted road tires 176.

In a preferred arrangement of wheel rotation assembly 110 the center-to-center distance X between adjacent axles of front-wheel rotation subassembly 150 and mid-wheel rotation subassembly 148 is about 11 feet nine inches. The preferred center-to-center distance Z between adjacent axles of mid-wheel rotation subassembly 148 and rear-wheel rotation subassembly 146 is about 22 feet. This preferred arrangement accommodates vehicle wheel bases between about 210 and 260 inches.

As previously noted, it is preferred that each wheel rotator 112 of wheel rotation assembly 110 be rotationally coupled to provide essentially contemporaneous coordinated rotation of all road-going wheels 104 of vehicle 108. Thus, each torque-transmitting axle 178 is preferably coupled by a set of torque couplers 122, preferably comprising either a short inter-axle drive coupler 186 or longer drive shafts 134, as shown (at least embodying herein at least one set of torque couplers structured and arranged to couple the torque received through at least one vehicle-drivetrain differential to essentially all other vehicle-drivetrain differentials of such at least one set).

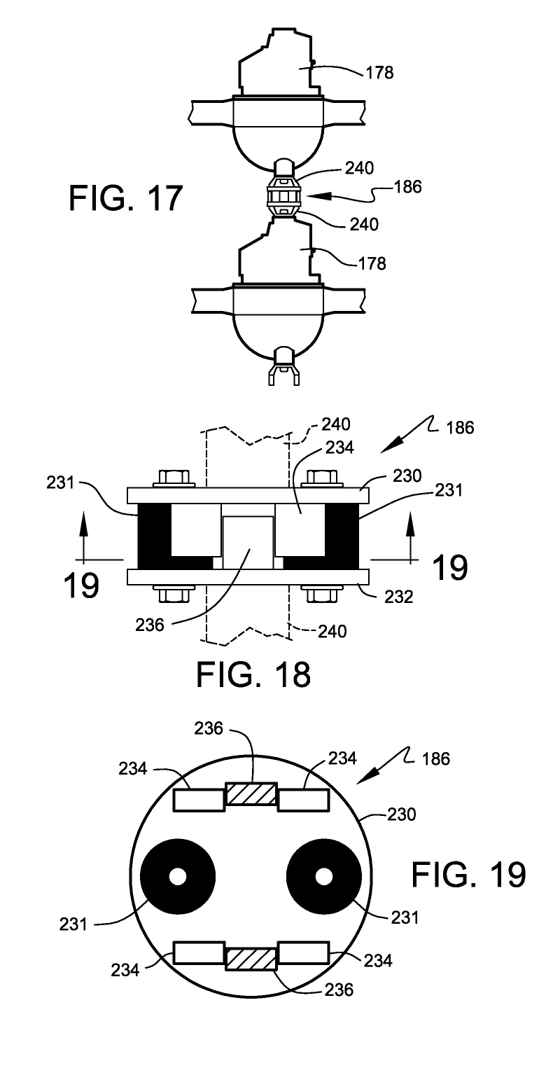

The short inter-axle drive couplers 186 are preferably used to couple the adjacent torque-transmitting axles 178 within rear-wheel rotation subassembly 146 and within mid-wheel rotation subassembly 148, as shown. The preferred structures and arrangements of inter-axle drive couplers 186 are presented in FIG. 17 through FIG. 19.

The longer drive shafts 134 preferably span between rear-wheel rotation subassembly 146 and mid-wheel rotation subassembly 148 and between mid-wheel rotation subassembly 148 and front-wheel rotation subassembly 150, as shown. Drive shafts 134 are of a conventional propeller-shaft design and preferably comprise customary universal-joint couplers, yokes, yoke straps, slip joints (to facilitate assembly), etc. Drive shafts 134 preferably comprise a maximum unsupported length of about 60 inches and are preferably supported at intermediate points by carrier bearings 190, as best illustrated in FIG. 5 and FIG. 14. Thus, the rotation of the drive wheels of vehicle 108 (preferably coupled by supported contact with a set of rollers 112) powers the rotation of the other rollers 112 (and, as a result, any other wheels 104 of vehicle 108 in contact with a set of rollers 112).

A bearing-mounted rolling bar 182 is preferably located between each tandem axle pair of rear-wheel rotation subassembly 146 and mid-wheel rotation subassembly 148, as shown. Rolling bar 182 preferably functions to limit the vertical drop experienced by the wheels 104 of vehicle 108 as they move between wheel-mounted road tires 176. They also assist in accommodating vehicles 108 of intermediate wheel base lengths. The ends of rolling bar 182 are preferably supported within pillow block-type bearings 184, as shown. The inboard pillow block-type bearings 184 are preferably bolted to upper beam flange 156, as shown. The outboard pillow block-type bearings 184 are preferably supported within a rigid pocket mounted to steel angle 170, as shown. The axis of rotation of each pillow block-type bearings 184 is substantially parallel to the rotational axes of the wheel-mounted road tires 176.

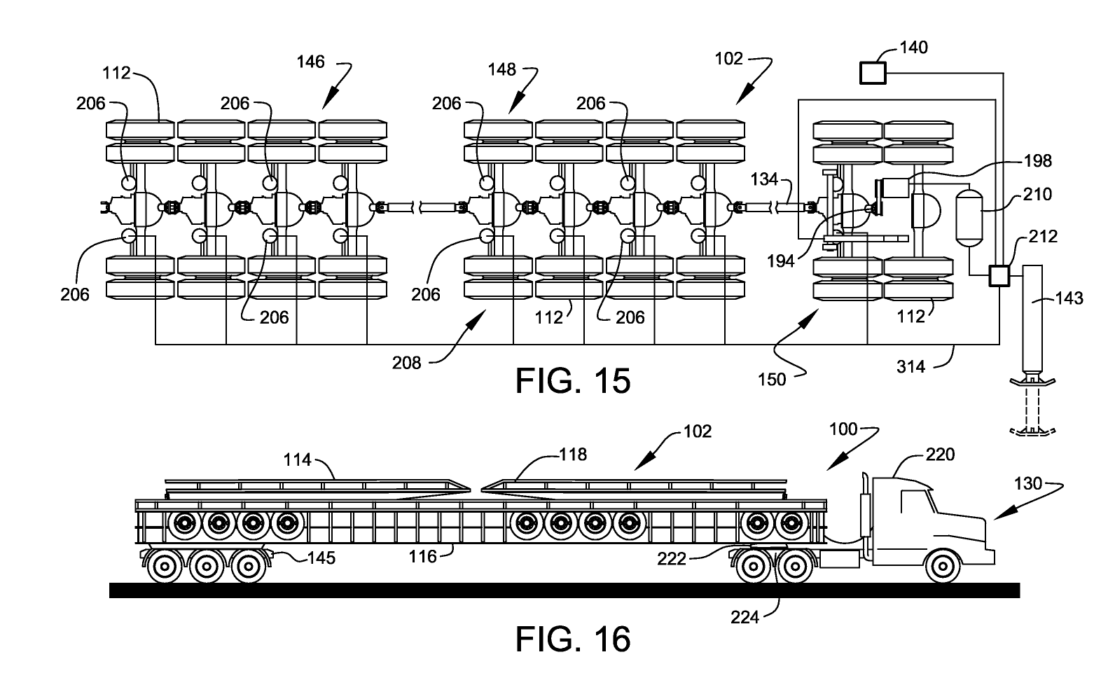

Front-wheel rotation subassembly 150 preferably comprises a torque-transmitting axle 178 and a forward-positioned free-wheeling idler axle 192, as shown. Torque-transmitting axle 178 is preferably coupled to mid-wheel rotation subassembly 148 by drive shafts 134, as shown. Torque-transmitting axle 178 of front-wheel rotation subassembly 150 preferably comprises a power take-off 194 functioning to extract usable power from a portion of the torque received through torque-transmitting axle 178. Power take-off 194 is preferably coupled to equipment unit 196, preferably containing an onboard air compressor 198 to supply pressurized air to operate the wheel-braking system of portable track-out prevention apparatus 102 (see FIG. 15).

A symmetrical set of side guards 200 preferably flank each side of front-wheel rotation subassembly 150, mid-wheel rotation subassembly 148, and rear-wheel rotation subassembly 146, as shown. Side guards 200 are preferably used to maintain vehicle 108 in a preferred generally centered position over wheel rotators 112. Side guards 200 further preferably function to prevent sidewall scrubbing and tire damage within wheels 104 as they are rotated. Each side guard 200 preferably comprises an elongated plate 202 rigidly mounted to guide rail 173 in a substantially parallel orientation, as shown. Each side guard 200 preferably supports a plurality of rollers 204 positioned to protectively engage the side walls of the vehicle tires should they drift in a transverse direction during rotation. Each roller 204 preferably comprises a 360-degree conveyor-type ball transfer unit mounted closely adjacent wheel-mounted road tires 176, as shown.

FIG. 15 shows a schematic diagram illustrating preferred pneumatic control arrangements of portable track-out prevention apparatus 102. At least one wheel rotator 112 of wheel rotation assembly 110 preferably comprises an air brake 206 to allow an operator control the rotation of wheel rotators 112. More preferably, each tandem axle comprises an air brake 206 preferably coupled to pneumatic braking subsystem 208, as shown (at least embodying herein at least one brake structured and arranged to brake such at least one tire rotator). Preferably, air pressure used to operate the braking subsystem is supplied by the onboard air compressor 198 powered by power takeoff 194. Upon reading this specification, those with ordinary skill in the art will now appreciate that, under appropriate circumstances, considering such issues as cost, user preference, etc., other equipment arrangements such as, for example, utilizing a gas-powered compressor, utilizing an onboard alternator and battery to generate electrical power derived from the power takeoff, etc., may suffice. Air compressor 198 preferably supplies pressurized air to an onboard air storage tank 210, as shown (at least embodying herein at least one air-storage reservoir structured and arranged to store a volume of pressurized air). Distribution of the pressurized air to air brakes 206 is preferably routed from air tank 210 through at least one pneumatic circuit 214 preferably comprising pneumatic piping routed throughout support platform 116. Airflow within pneumatic circuit 214 is preferably controlled by at least one electrically operated valve unit 212 electrically coupled with post-mounted control unit 140, as shown. Post-mounted control unit 140 preferably comprises one or more user controls and is preferably located in a position accessible to the operator of vehicle 108, thus allowing the vehicle operator to brake and release the wheel rotators 112. Upon reading this specification, those with ordinary skill in the art will now appreciate that, under appropriate circumstances, considering such issues as cost, user preference, etc., other control arrangements such as, for example, providing automated brake-control functionality, providing visual indicators including warning lights, providing auditory indicators including warning annunciators, providing closed circuit video to allow the operator to observe the cleaning operations from the cab of the vehicle, utilizing remote control devices to allow remote operation of the system, etc., may suffice.

In preferred use vehicle 108 drives onto the system by driving up vehicle entry ramp 114 onto support platform 116, as shown. Preferably, the operator of vehicle 108 moves forward until the wheels 104 of vehicle 108 are engaged within wheel rotators 112 of wheel rotation assembly 110, as best illustrated in FIG. 1 and FIG. 2. Preferably, the operator of vehicle 108 engages a mechanical restraining hook 180 (preferably adapted to engage at least one portion of the chassis of vehicle 108 to assure that the vehicle will remain stationary during a subsequent debris removal operation) and releases the air brakes restraining the rotation of rollers 112 by manipulating user controls 216 of post-mounted control unit 140 (preferably located near the cab of vehicle 108). Preferably, each wheel rotator 112 of wheel rotation assembly 110 is then free to rotate (in a rotationally coordinated manner). Next, the operator of vehicle 108 preferably initiates operation of the vehicle as in normal driving. Preferably, rotation of the drive wheels 105 of vehicle 108 initiates rotation of all other wheels 104 in contact with wheel rotation assembly 110. Preferably, the operator of vehicle 108 continues the rotation until a sufficient amount of debris has been removed from the wheels. Preferably, the operator of vehicle 108 then re-engages the brakes (controlling the rotation of rollers 112) and releases the restraining hook 180 allowing the vehicle to move forward exiting support platform 116 by passing over exit ramp 118. During passage over portable track-out prevention apparatus 102, further debris is removed from the wheels by contact with the vibration-inducing surfaces 126. Upon reading this specification, those with ordinary skill in the art will now appreciate that, under appropriate circumstances, considering such issues as environmental regulations, cost, etc., other features and arrangements such as, for example, providing an arrangement of dust-suppressing misters along the system chassis, etc., may suffice.

FIG. 16 shows a side view, in partial section, illustrating portable track-out prevention apparatus 102 configured for relocation by towing vehicle 130, preferably a semi-type tractor 220, according to the preferred embodiment of FIG. 1. Portable track-out prevention apparatus 102 is preferably designed to be reconfigured for towing between deployment sites. Portable track-out prevention apparatus 102 preferably comprises a set of pneumatically-operated (or alternately preferably, hydraulically-operated) telescoping support legs 143 adapted to raise and lower support platform 116 (see FIG. 15). Support legs 143 are preferably used to lift support platform 116 to an elevation sufficiently high to allow the placement of wheel assembly 145 and to allow the attachment of king-pin 222 to a fifth wheel coupling assembly 224 of the towing vehicle 130 (such as a semi-type tractor), as shown in FIG. 2. Upon reading the teachings of this specification, those of ordinary skill in the art will now understand that, under appropriate circumstances, considering such issues as intended use, size, etc., other hitch arrangements, such as pintle hooks, drawbar, pin hitch, permanent connections, etc., may suffice. Furthermore, upon reading the teachings of this specification, those of ordinary skill in the art will now understand that, under appropriate circumstances, considering such issues as intended use, etc., other wheel arrangements, such as utilizing permanently affixed on-board wheels, deployed by hydraulics or other means, etc., may suffice.

To facilitate movement, it is preferred that entry ramp 114 and exit ramp 118 be removable so that they may be stacked on support platform 116 during transport, as shown. Upon reading the teachings of this specification, those of ordinary skill in the art will now understand that, under appropriate circumstances, considering such issues as intended use, etc., other arrangements, such as hinged arrangements, multi-part chassis arrangements, etc., may suffice.

FIG. 17 shows a partial enlarged plan view illustrating a preferred inter-axle drive coupler 186 used to rotationally couple sets of adjacent torque-transmitting axles 178 of a wheel rotation assembly of portable track-out prevention apparatus 102. FIG. 18 shows a plan view illustrating the preferred inter-axle drive coupler 186 of FIG. 17. FIG. 19 shows a sectional view through the section 19-19 of FIG. 18 further illustrating the preferred inter-axle drive coupler 186 of FIG. 17.

Inter-axle drive coupler 186 preferably comprises first plate 230 and a spaced apart second plate 232, as shown. A first set of teeth 234 preferably project outwardly from first plate 230, as shown. The first set of teeth 234 are preferably structured and arranged to inter-engage with a second set of teeth 236 preferably projecting outwardly from second plate 232. Rotation of first plate 230 results in the rotation of second plate 232 as a result of the contact engagement between the first set of teeth 234 and the second set of teeth 236. Rotational forces are thus transferred between the two plates by interference between the opposing teeth. A set of rubber attenuators 231 are preferably bolted between first plate 230 and the second plate 232 to attenuate sudden loading of the teeth during torque transfer. Each plate is rigidly welded to a yoke member 240 compatible with the input and output shafts of the adjacent torque-transmitting axles 178.

FIG. 20 shows an overall plan view of alternate portable track-out prevention apparatus 300 according to a second preferred embodiment of track-out prevention system 100. FIG. 21 shows an overall side view of the same alternate portable track-out prevention apparatus 300 of FIG. 20.

Alternate portable track-out prevention apparatus 300 preferably operates by the simultaneous rotation of all road-going wheels 104 of vehicle 108 (as diagrammatically illustrated in FIG. 1 and FIG. 2). This preferred action serves to dislodge and remove debris from the wheels and tires by centripetal forces generated during wheel rotation. Secondarily, debris is removed from vehicle 108 by secondary debris-dislodging regions 124 located along the path of the vehicle.

Alternate portable track-out prevention apparatus 300 preferably comprises an elevated vehicle support platform 116 adapted to support vehicle 108 in a substantially stationary position, as shown. Vehicle support platform 116 preferably comprises a wheel rotation assembly 110 (at least embodying herein at least one tire rotator) based on a substantially continuous arrangement of “low profile” wheel rotators 112. Each wheel rotator 112 is preferably adapted to engage one or more rolling wheels 104 of vehicle 108 (as generally illustrated in FIG. 1). Except as noted below, it is preferred that each wheel rotator 112 of wheel rotation assembly 110 be rotationally coupled to preferably provide essentially contemporaneous coordinated rotation of all road-going wheels 104 of vehicle 108, as shown in both FIG. 1 and FIG. 2. It is again preferred that the rotation of each wheel rotator 112 be power driven, most preferably power driven by rotational power extracted from the drive wheels 105 of vehicle 108. Each wheel rotator 112 is preferably intercoupled by a series of torque couplers (see FIG. 25) adapted to distribute the rotational power (torque) received from drive wheels 105 between the wheel rotators 112 of wheel rotation assembly 110.

Wheel rotators 112 of wheel rotation assembly 110 are preferably located in positions within support platform 116 generally coinciding with the locations of the plurality of wheels 104 of vehicle 108. The preferred use of many adjacent rotators functions to accommodate vehicles of various lengths.

In addition to wheel rotation assembly 110, support platform 116 preferably comprises multiple secondary debris-dislodging regions 124 structured and arranged to provide secondary dislodging of debris from vehicle 108. Each secondary debris-dislodging region 124 preferably comprises at least one vibration-inducing surface 126 structured and arranged to induce debris-dislodging vibrations within vehicle 108 during movement of vehicle 108 over support platform 116.

Vehicle 108 preferably accesses support platform 116 by traversing an upwardly inclined entry ramp 352. A downwardly sloping exit ramp 354 is preferably located at the opposing end of support platform 116 to provide ramp-assisted exiting of vehicle 108. Both entry ramp 352 and exit ramp 354 comprise shorter lengths than their respective counterparts servicing portable track-out prevention apparatus 102. This is due to the preferred “low profile” support height of support platform 116.

Both entry ramp 352 and exit ramp 354 preferably comprise secondary debris-dislodging regions 124, as shown. As noted previously, secondary debris-dislodging regions 124 preferably comprise vibration-inducing surfaces 126 adapted to induce debris-dislodging vibrations in vehicle 108 as it drives over alternate portable track-out prevention apparatus 300. Each secondary debris-dislodging region 124 of the entry and exit ramps preferably comprises a plurality of spaced-apart transverse bars 136 located substantially within the drive path 174 of vehicle 108, as shown. Each transverse bar 136 preferably comprises a length of round tube steel having an outer diameter of about three inches and a wall thickness of about ¼ inch. Each transverse bar 136 is preferably rigidly mounted to the underlying support structure at a center-to-center spacing of about eight inches. The preferred spacing between transverse bars 136 produces a vigorous shaking of wheels 104, undercarriage, chassis 106, and body of vehicle 108, thus dislodging dirt, gravel and other debris from their surfaces. Furthermore, the open regions formed between adjacent transverse bars 136 preferably allows the dislodged debris to fall through the transverse bars 136 to the ground surface below, thus limiting the build-up of debris within the drive path 174 of vehicle 108.

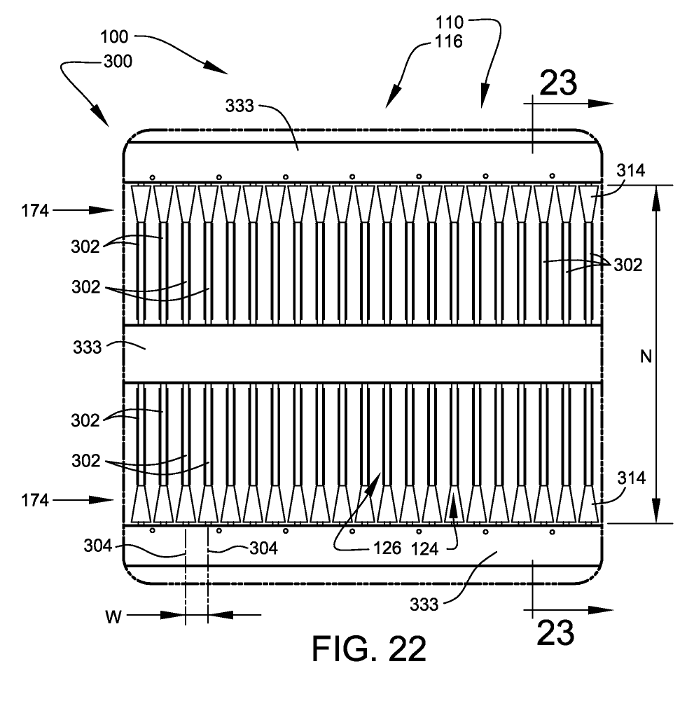

FIG. 22 shows the partial enlarged plan view 22 of FIG. 20 illustrating a portion of alternate portable track-out prevention apparatus 300 of FIG. 20. Alternate portable track-out prevention apparatus 300 preferably comprises a plurality of supportive rollers 302 structured and arranged to rotatably support the plurality of wheels 104 of vehicle 108. Rollers 302 are preferably rotatably supported within support platform 116 and are preferably disposed in closely-adjacent spaced relation, as shown. The preferred close interspacing of rollers 302 forms a substantially continuous rolling surface for vehicle 108. This preferred arrangement allows alternate portable track-out prevention apparatus 300 to accommodate vehicles of many differing wheel base lengths and track widths. For example, alternate portable track-out prevention apparatus 300 is capable of servicing a short-wheelbase ¾-ton pickup truck (of sufficient horsepower) as well as long wheelbase semi-type tractor trailer rigs. Each roller 302 preferably comprises a central longitudinal axis 304 about which each roller 302 rotates. Preferred roller-to-roller spacing W, as preferably measured between longitudinal axes 304, is preferably between about six inches and about ten inches. A roller-to-roller spacing W of about eight inches is most preferred as this spacing has been found to accommodate most wheels/tire combinations.

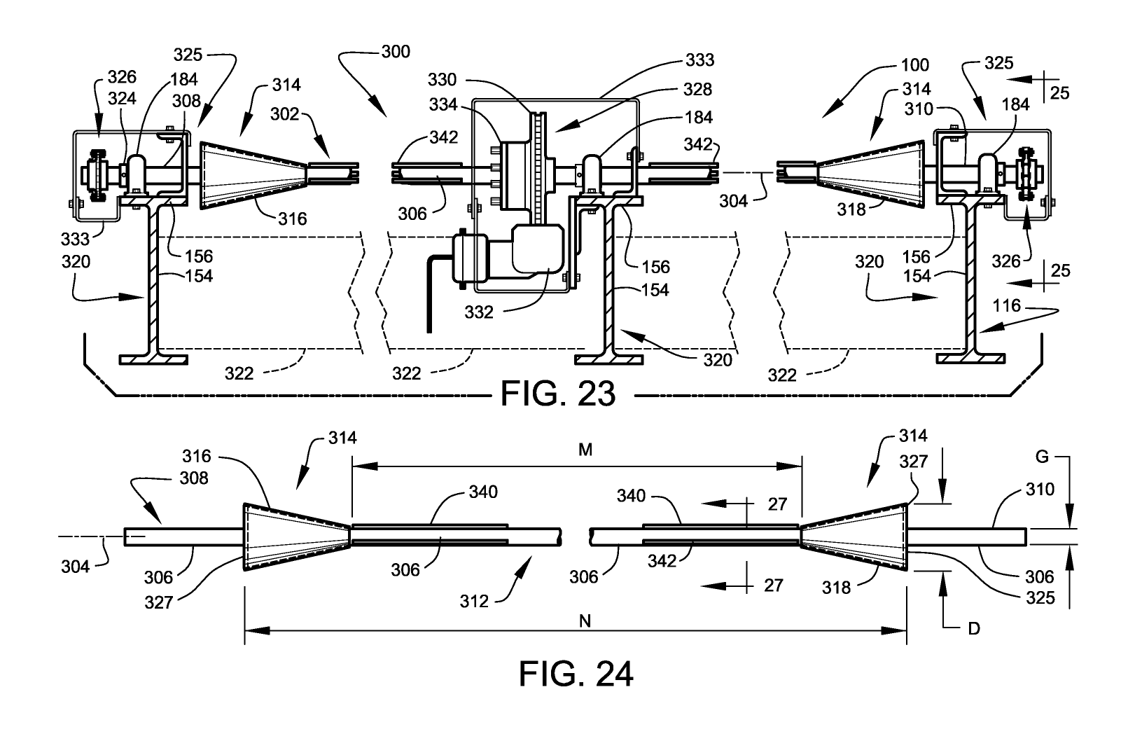

FIG. 23 shows the sectional view 23-23 of FIG. 22 illustrating preferred structural arrangements of alternate portable track-out prevention apparatus 300. FIG. 24 shows a side view of a single support roller 302 of wheel rotation assembly 110 of alternate portable track-out prevention apparatus 300. Each roller 302 preferably comprises a first end 308, a second end 310, and a center portion 312 situate between first end 308 and second end 310, as shown. Each roller 302 preferably comprises a central elongated bar 306 preferably extending continuously between first end 308 and second end 310, as shown. Elongated bar 306 preferably comprises at least one metallic composition, most preferably steel. Elongated bar 306 most preferably comprises a substantially solid and substantially cylindrical bar having an outer diameter G of about two inches.

Each elongated bar 306 is fitted with wheel-centering assembly 314 to assist in maintaining the vehicle's plurality of wheels 104 in a preferred position supported over center portion 312. Wheel-centering assembly 314 preferably comprises a first frustoconical portion 316 proximate to first end 308, as shown, and a second frustoconical portion 318 proximate to second end 310. Both first frustoconical portion 316 and second frustoconical portion 318 are substantially coaxial with longitudinal axis 304 (the rotational axis of roller 302), as shown. Both first frustoconical portion 316 and second frustoconical portion 318 each have a diameter preferably increasing with distance from center portion 312, as shown. The large diameter ends 327 of first frustoconical portion 316 and second frustoconical portion 318 each comprise the largest practical diameter D accommodated by the selected roller-to-roller spacing (a diameter D preferably approaching about eight inches).

The preferred distance M between first frustoconical portion 316 and second frustoconical portion 318 is about 116 inches. The overall track width N, as measured between the distal (large-diameter) faces of first frustoconical portion 316 and second frustoconical portion 318, preferably is about ten feet.

For durability, both first frustoconical portion 316 and second frustoconical portion 318 are preferably formed from a substantially rigid metal, most preferably steel. Upon reading this specification, those with ordinary skill in the art will now appreciate that, under appropriate circumstances, considering such issues as cost savings, vehicle model, etc., other wheel-centering arrangements such as, for example, providing an alternating arrangement of frustoconical portions wherein each roller comprises only one frustoconical portion, wherein the frustoconical portions of adjacent rollers alternate between right and left positions, etc., may suffice.

Alternate portable track-out prevention apparatus 300 is preferably constructed using multiple elongated structural members 320, each preferably comprising a steel structural member, more preferably a wide-flange-type beam 154, as shown. Each wide-flange-type beam 154 preferably extends substantially the full length L of support platform 116 in substantially parallel orientation. Structural cross members 322 (shown by the dashed line designations of FIG. 23) preferably extend between wide-flange-type beams 154 to maintain the respective members in a geometrically fixed relationship. Upon reading this specification, those with ordinary skill in the art will now appreciate that, under appropriate circumstances, considering such issues as cost, user preference, etc., other structural support arrangements such as, for example, using four parallel structural wide-flange members, using four parallel open truss members etc., may suffice.

Each roller 302 is preferably supported at multiple points by pillow block-type bearings 184, as shown. The pillow block-type bearings 184 are preferably mounted to respective upper surfaces of the upper beam flanges 156 of the middle and outer wide-flange-type beams 154, as shown. Translational movement of rollers 302, along their longitudinal axes 304, is preferably controlled by one piece or two-piece set-screw type shaft collars 324 mounted thereon.

During preferred operation, the torque received through one supportive roller 302 of support platform 116 is preferably transmitted to substantially all other rollers 302 of the apparatus. In alternate portable track-out prevention apparatus 300 rotational “coupling” of the rollers is preferably accomplished by an alternating arrangement of torque couplers 325 organized to distribute torque received from drive wheels 105 of vehicle 108 to the full plurality of rollers 302. Torque couplers 325 preferably comprise an arrangement of power-distributing chain drives 326, as shown.

Braking of rollers 302 is preferably accomplished by an arrangement of inboard brakes 328 preferably mounted to the central wide-flange-type beam 154, as shown. Brakes 328 preferably comprise one or more air-actuated disc-type brakes preferably derived from an automotive application. Each brake 328 preferably comprises disc-type rotor 330 rotatably engaged within at least one air-actuated caliper body 332, as shown. A set of flanged adapters 334 may be used to rigidly engage disc-type rotor 330 with elongated bar 306. Upon reading this specification, those with ordinary skill in the art will now appreciate that, under appropriate circumstances, considering such issues as cost, user preference, etc., other braking arrangements such as, for example the use of outboard brake positions, drum-type brakes, brakes coupled to the chain drive, etc., may suffice.

To improve service life and promote safety, chain drives 326 and brakes 328 are preferably partially enclosed within protective shrouding 333, as shown. Protective shrouding 333 may preferably comprise a sheet metal assembly adapted for easy removal during servicing. Portions of the shrouding may preferably function as a drip pan to collect lubricating oil/grease associated with chain drives 326.

FIG. 25 shows a partial side view illustrating the preferred power-distributing chain drives 326 of the alternate portable track-out prevention apparatus 300. FIG. 26 shows a partial plan view illustrating the preferred alternating coupling arrangements of the chain drives 326 of FIG. 25.

In a preferred arrangement of torque couplers 325, first end 308 and second end 310 of each roller 302 are preferably fitted with at least one roller-chain sprocket 336, as shown. Each sprocket 336 is adapted to engage at least one continuously looped roller chain 338, as shown, most preferably a single strand No. 60 (“RS60”-type) roller chain.

Each sprocket 336 preferably comprises an outer sprocket diameter of about four inches and a pitch diameter matched to roller chain 338. Roller chains 338 are preferably engaged on alternating pairs of adjacent sprockets 336, as best illustrated in FIG. 26. This preferred arrangement enables a simultaneous unidirectional rotation of all rollers 302. Upon reading this specification, those with ordinary skill in the art will now appreciate that, under appropriate circumstances, considering such issues as cost, user preference, etc., other rotational coupling arrangements such as, for example drive belts, multiple gear trains, double roller chains, etc., may suffice.

Preferably, at least one chain drive 326 is coupled to equipment unit 396, preferably containing an onboard air compressor, air tank, and pneumatic valves used to supply pressurized air and operate the wheel-braking system in addition to other pneumatic apparatus of the embodiment. It is noted that the pneumatic subsystem of alternate portable track-out prevention apparatus 300 preferably operates in a manner substantially similar to the pneumatic subsystem of portable track-out prevention apparatus 102 (see FIG. 15). Upon reading this specification, those with ordinary skill in the art will now appreciate that, under appropriate circumstances, considering such issues as cost, user preference, etc., other power arrangements such as, for example, coupling the chain drive to a prime mover, such as a motor or engine, etc., may suffice.

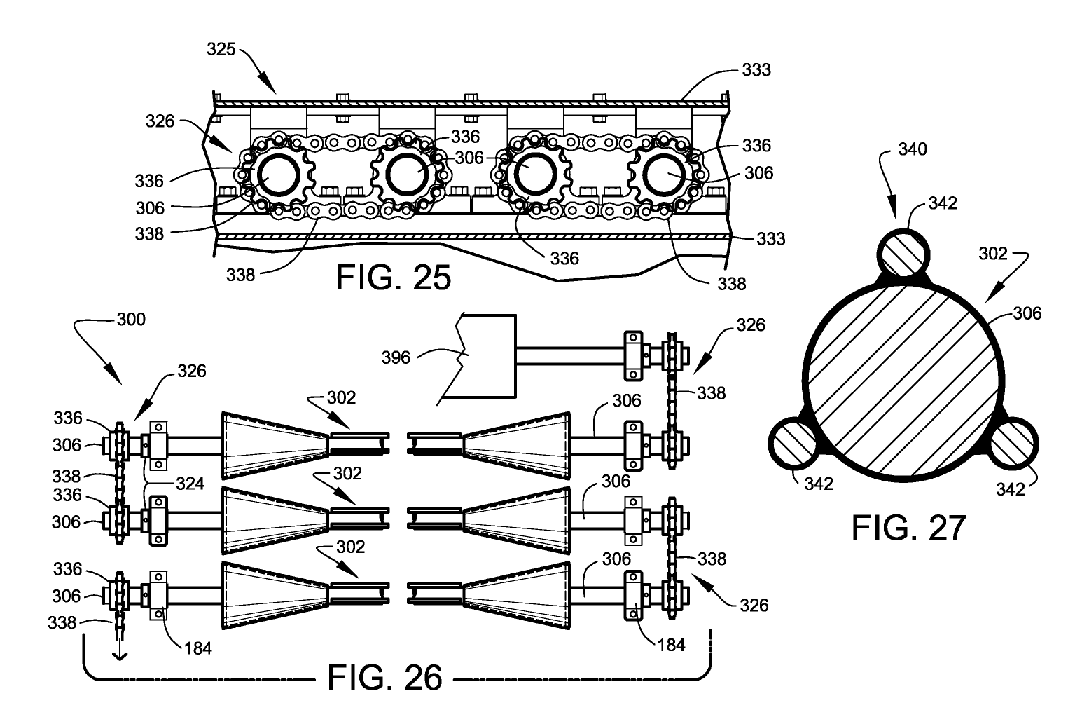

FIG. 27 shows the sectional view 27-27 of FIG. 24 illustrating preferred structures and arrangements of elongated bar 306 of roller 302. Each roller 302 preferably comprises at least one uneven outer peripheral surface 340 preferably adapted to generate within support platform 116, an integral secondary debris-dislodging region 124. Uneven outer peripheral surface 340 of each roller 302 is preferably produced by attaching, more preferably thermally welding, a set of small-diameter rumble bars 342 to the outer circumference of elongated bar 306, as shown. In a preferred arrangement, ½-inch diameter steel rumble bars 342 are welded to elongated bar 306 at about an equal 120-degree spacing, as shown. The axis of each rumble bar 342 is preferably oriented substantially parallel to longitudinal axis 304, as shown. Each rumble bar 342 may preferably comprise a segment of No. 4 steel-reinforcing bar. During preferred operation, rumble bars 342 generate a debris-removing vibration as the rollers rotate beneath wheels 104 of vehicle 108. Upon reading this specification, those with ordinary skill in the art will now appreciate that, under appropriate circumstances, considering such issues as cost, user preference, etc., other cleaning arrangements such as, for example, mounting one or more wheel-cleaning brushes within the vehicle drive path, mechanically rotating one or more wheel-cleaning brushes using power derived from the wheel rotation mechanism, etc., may suffice.

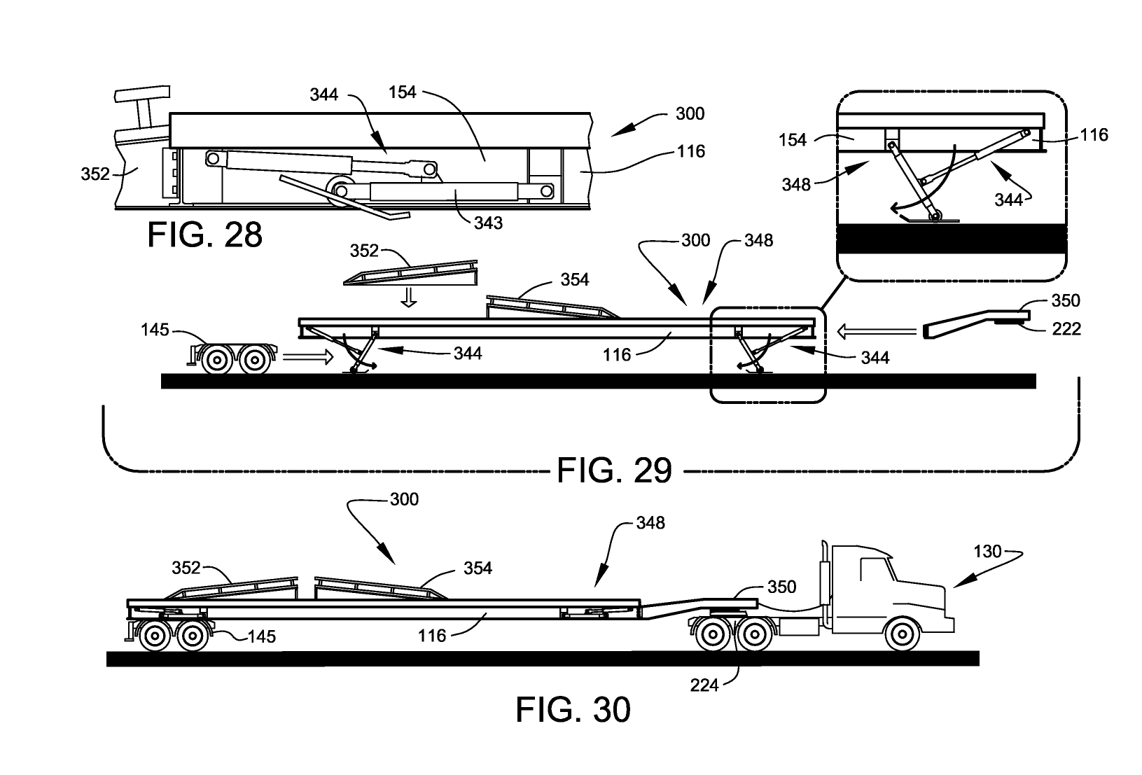

FIG. 28 shows a partial side view illustrating an onboard lift mechanism 344 used to lift alternate portable track-out prevention apparatus 300 from ground-supported position 346 (see FIG. 21) to raised position 348. FIG. 29 shows a side view, illustrating alternate portable track-out prevention apparatus 300 being configured for relocation by towing truck 130, according to the preferred embodiment of FIG. 20.

Alternate portable track-out prevention apparatus 300 is preferably designed to be reconfigured for towing between deployment sites. Lift mechanism 344 of alternate portable track-out prevention apparatus 300 preferably comprises a set of pneumatically-operated (or alternately preferably, hydraulically-operated) support legs 343 adapted to raise and lower alternate portable track-out prevention apparatus 300. Support legs 343 are preferably used to lift support platform 116 to an elevation sufficiently high to allow the placement of wheel assembly 145 and to allow the attachment of a forward goose neck assembly 350, as shown.

Goose neck assembly 350 preferably comprises king-pin 222 adapted to engage a fifth wheel coupling assembly 224 of towing vehicle 130. Upon reading the teachings of this specification, those of ordinary skill in the art will now understand that, under appropriate circumstances, considering such issues as intended use, size, etc., other hitch arrangements, such as pintle hooks, drawbar, pin hitch, permanent connections, etc., may suffice. Furthermore, upon reading the teachings of this specification, those of ordinary skill in the art will now understand that, under appropriate circumstances, considering such issues as intended use, etc., other wheel arrangements, such as utilizing permanently affixed on-board wheels, deployed by hydraulics or other means, etc., may suffice.

To facilitate movement, it is preferred that entry ramp 352 and exit ramp 354 be removable so that they may be stacked on support platform 116 during transport, as shown. Upon reading the teachings of this specification, those of ordinary skill in the art will now understand that, under appropriate circumstances, considering such issues as intended use, etc., other arrangements, such as hinged arrangements, multi-part chassis arrangements, etc., may suffice.

FIG. 30 shows a side view, illustrating alternate portable track-out prevention apparatus 300 configured for relocation by towing vehicle 130, according to the preferred embodiment of FIG. 20.

Although applicant has described some of applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A system relating to the removal of surface accumulations of debris from at least one vehicle having a plurality of rollable tires rotationally mounted thereon, said system comprising:
a) at least one vehicle support structured and arranged to support the at least one vehicle in at least one substantially stationary position;
b) wherein said at least one vehicle support comprises at least one tire rotator structured and arranged to essentially contemporaneously rotate substantially each one of the plurality of rollable tires of the at least one vehicle supported by said at least one vehicle support;
c) wherein said at least one tire rotator comprises at least one power extractor structured and arranged to extract rotational power from the at least one vehicle;
d) wherein said at least one tire rotator operates substantially by such rotational power derived from the at least one vehicle; and
e) wherein rotation of the plurality of rollable tires by said at least one tire rotator assists in dislodging debris from the at least one vehicle.

2) The system according to claim 1 wherein said at least one vehicle support further comprises:
a) at least one wheel-assisted towing assembly structured and arranged to assist wheeled towing of said at least one vehicle support;
b) wherein said at least one wheel-assisted towing assembly comprises
i) at least one wheel set structured and arranged to assist rolling movement of said at least one vehicle support, and
ii) at least one hitch coupler structured and arranged to assist hitch coupling of said at least one vehicle support to at least one towing vehicle.

3) The system according to claim 2 wherein said at least one power extractor comprises at least one contact interaction between at least one powered rolling tire of the plurality of rollable tires and said at least one tire rotator.

4) The system according to claim 3 wherein said at least one vehicle support further comprises:
a) at least one elevated platform structured and arranged to support the at least one vehicle above a ground surface;
b) at least one vehicle entry ramp structured and arranged to provide ramp-assisted vehicle entry of the at least one vehicle onto said at least one vehicle support; and
c) at least one vehicle exit ramp structured and arranged to provide ramp-assisted vehicle exiting of the at least one vehicle from said at least one vehicle support.

5) The system according to claim 4 wherein said at least one vehicle entry ramp and said at least one vehicle exit ramp are substantially detachable from said at least one vehicle support to assist such wheel-assisting towing.

6) The system according to claim 5 wherein said at least one vehicle support further comprises:
a) at least one secondary debris-dislodger structured and arranged to provide secondary dislodging of debris from the at least one vehicle;
b) wherein said at least one secondary debris-dislodger comprises at least one vibration-inducing surface structured and arranged to induce debris-dislodging vibrations in the at least one vehicle during movement of the at least one vehicle over said at least one secondary debris-dislodger.

7) The system according to claim 6 wherein:
a) said at least one vehicle entry ramp comprises at least one portion of said at least one secondary debris-dislodger; and
b) said at least one vehicle entry ramp is further structured and arranged to dislodge debris from the at least one vehicle during such vehicle entry.

8) The system according to claim 7 wherein:
a) said at least one vehicle exit ramp comprises at least one portion of said secondary debris-dislodger; and
b) said at least one vehicle exit ramp is further structured and arranged to dislodge debris from the at least one vehicle during such vehicle exit.

9) The system according to claim 8 wherein said at least one vibration-inducing surface substantially comprises a plurality of spaced-apart transverse bars located substantially within the drive path of the at least one vehicle.

10) The system according to claim 8 wherein at least one of said at least one vibration-inducing surface substantially comprises at least one area of loose aggregate material located substantially within the drive path of the at least one vehicle.

11) The system according to claim 6 wherein said at least one tire rotator comprises:
a) at least one plurality of supportive rollers structured and arranged to rotatably support the plurality of rollable tires; and
b) at least one set of torque couplers structured and arranged to couple the torque received through at least one supportive roller of said at least one plurality of supportive rollers to substantially all other such supportive rollers of said at least one plurality of supportive rollers.

12) The system according to claim 11 wherein each such at least one supportive roller said at least one plurality of supportive rollers comprises:
a) at least one elongated bar comprising at least one first end portion, at least one second end portion, and at least one center portion situate therebetween; and
b) at least one centering assembly structured and arranged to assist in maintaining the at least one rollable tire in at least one supported position proximate to said at least one center portion.

13) The system according to claim 12 wherein said at least one centering assembly comprises:
a) proximate with said at least one first end portion, at least one first frustoconical portion comprising a diameter increasing with distance from said at least one center portion; and
b) proximate with said at least one second end portion, at least one second frustoconical portion comprising a diameter increasing with distance from said at least one center portion;
c) wherein said at least one elongated bar comprises at least one rotational axis; and
d) wherein said at least one first frustoconical portion and said at least one second frustoconical portion are disposed substantially coaxially with said at least one rotational axis.

14) The system according to claim 12 wherein said at least one set of torque couplers comprises at least one power-distributing chain drive structured and arranged to distribute rotary power between substantially each at least one rotatable bar of said at least one plurality of supportive rollers.

15) The system according to claim 12 wherein:
a) said at least one elongated bar further comprises at least one portion of said at least one secondary debris-dislodger; and
b) said at least one portion of said at least one secondary debris-dislodger comprises at least one uneven outer peripheral surface of such at least one rotatable bar.

16) The system according to claim 11 wherein said at least one tire rotator further comprises at least one power take-off structured and arranged to extract usable power from a portion of the torque received through such at least one supportive roller of said at least one plurality of supportive rollers.

17) The system according to claim 16 further comprising:
a) at least one brake structured and arranged to brake said at least one tire rotator; and
b) at least one user control structured and arranged to assist user control of said at least one brake.

18) The system according to claim 17 further comprising:
a) at least one air pump structured and arranged to pressurize air by pumping;
b) at least one air-storage reservoir structured and arranged to store a volume of pressurized air;
c) at least one pneumatically-powered brake actuator structured and arranged to assist pneumatic actuation of said at least one brake;
d) at least one pneumatic circuit structured and arranged to operably couple said at least one air-storage reservoir and said at least one pneumatically-powered brake actuator; and
e) at least one pneumatic control valve structured and arranged to control the application of such pressurized air at said at least one pneumatically-powered brake actuator;
f) wherein the operation of said at least one pneumatic control valve is substantially controlled by said at least one user control; and
g) wherein the operation of said at least one air pump is enabled using the usable power provided at said at least one power take-off.

19) The system according to claim 18 further comprising at least one positional restraint structured and arranged to restrain the at least one vehicle in a substantially fixed position relative to said at least one vehicle support.

20) The system according to claim 18 further comprising:
a) at least one mechanically-powered lift structured and arranged to lift said at least one vehicle support to at least one position assisting placement of said at least one wheel-assisted towing assembly and coupling to the at least one towing vehicle.

21) The system according to claim 6 wherein said at least one tire rotator comprises:
a) at least one set of wheel-mounted road tires structured and arranged to support the plurality of rollable tires;
b) at least one set of vehicle-drivetrain differentials structured and arranged to rotationally support said set of wheel-mounted road tires; and
c) at least one set of torque couplers structured and arranged to couple the torque received through at least one vehicle-drivetrain differential to substantially all other vehicle-drivetrain differentials of said at least one set.

22) The system according to claim 21 wherein said at least one tire rotator further comprises at least one power take-off structured and arranged to extract usable power from a portion of the torque received through such at least one vehicle-drivetrain differential.

23) The system according to claim 22 further comprising:
a) at least one brake structured and arranged to brake said at least one tire rotator; and
b) at least one user control structured and arranged to assist user control of said at least one brake.

24) A method relating to the removal of surface accumulations of debris from at least one vehicle having a plurality of rollable tires rotationally mounted thereon, such method comprising the steps of:
a) supporting the at least one vehicle in at least one substantially stationary position;
b) engaging the plurality of rolling tires within at least one tire rotator structured and arranged to essentially contemporaneously rotate substantially each one of the plurality of rollable tires;
c) extracting rotational power from the at least one vehicle;
d) operating such at least one tire rotator using such extracted rotational power; and
e) dislodging debris from the at least one vehicle by rotation of the plurality of rollable tires by said tire rotator.

25) A system relating to prevention material track-out by at least one vehicle having a plurality of rollable tires rotationally mounted thereon, said system comprising:
a) vehicle support means for supporting the at least one vehicle in at least one substantially stationary position;
b) wherein said vehicle support means comprises tire rotator means for rotating substantially each one of the plurality of rollable tires of the at least one vehicle supported by said tire support means;
c) wherein said tire rotator means comprises power extractor means for extracting rotational power from the at least one vehicle;
d) wherein said tire rotator means substantially operates by such rotational power derived from the at least one vehicle; and
e) wherein rotation of the plurality of rollable tires by said tire rotator means assists in dislodging debris from the at least one vehicle.
